(19) United States
(12) Patent Application Publication
(10) Pub. No.: US 2014/0023724 A1
(43) Pub. Date: Jan. 23, 2014

(54) METHOD FOR PRODUCING REDUCED WATER AND APPARATUS FOR PRODUCING REDUCED WATER

(71) Applicant: Katsuya Fujimura, Saitama (JP)

(72) Inventor: Katsuya Fujimura, Saitama (JP)

(73) Assignee: NTC DREAM MAX CO., LTD.

(21) Appl. No.: 14/005,335

(22) PCT Filed: Oct. 31, 2011
(86) PCT No.: PCT/JP2011/075040

§ 371 Date: Oct. 10, 2013

(30) Foreign Application Priority Data
Mar. 17, 2011 (JP) 2011-058797
Sep. 1, 2011 (JP) 2011-190886

(51) Int. Cl. C02F 1/461

(52) U.S. Cl. CPC C02F 1/461
USPC 424/600; 426/531; 205/464; 422/162; 204/194

(57) ABSTRACT

The problem of the present invention is to provide a method or the like for producing reduced water (hydrogen-enriched water), which is effective for various diseases caused by active oxygen, more efficiently than the conventional methods, by putting metallic magnesium or the like in water. Adding a metal such as magnesium, together with a solid phase contained in an anode of an oxidation-reduction reaction, to water increases the saturating amount of magnesium ions, and improves deterioration due to magnesium hydroxide being precipitated on the surface of the metallic magnesium. Thus, the abovementioned problem is solved.

### TECHNICAL FIELD

The present invention provides a method for producing reduced water, in which hydrogen is generated in water using metallic magnesium, an apparatus for producing reduced water, etc.

### BACKGROUND ART

Reduced water prepared using metallic magnesium or the like is rich in hydrogen, and is also called hydrogen-enriched water. Hydrogen-enriched water has antioxidant properties and protects cells (Non-Patent Document 1). It was actually demonstrated in animal and human experiments that hydrogen-enriched water has anti-allergic, anti-inflammatory and antioxidant properties, and it has effects on various diseases. There are reports of animal and human experiments reporting that hydrogen-enriched water has effects on, for example, arteriosclerosis (Non-Patent Document 2), Alzheimer's disease (Non-Patent Document 3), memory improvement (Non-Patent Document 4), type II diabetes (Non-Patent Document 5), Parkinson's disease (Non-Patent Document 6), liver disorder (Non-Patent Document 7), myocardial infarction (Non-Patent Document 8), allergy (Non-Patent Document 9) and metabolic syndrome (Non-Patent Document 10). Vitamin C is one of representative reducing agents and there are hydrophilic vitamin C and hydrophobic vitamin C, but these cannot necessarily reach the brain or the inside of a cell. Meanwhile, hydrogen passes through hydrophobic cell membranes and the brain barrier (Non-Patent Document 1) and easily reaches the entire body, and therefore is an ideal reducing agent.

Hydrogen-enriched water is provided by various methods, and typical examples thereof include electrolysis (Patent Document 1). When an aqueous solution is separated by an ion-exchange membrane and the voltage is applied using electrodes, anions are oxidized at the anode and cations are reduced at the cathode. Various ions are dissolved in tap water, but the matter as to which ion is oxidized or reduced depends on the oxidation-reduction potential (reduction potential) of dissolved ions and the concentration of ions. With respect to components, hydrogen is mainly generated at the cathode, and the solution becomes alkaline and is used as hydrogen-enriched water or alkaline reduced water. This method requires an apparatus into which an electrolysis apparatus is incorporated, and at this time, a noble metal such as platinum is used for electrodes. Therefore, there is a problem that the apparatus is expensive.

As another method, injection of hydrogen gas into water can be employed. Hydrogen can be dissolved at up to 1.6 ppm that is the saturation concentration, but in the course of putting hydrogen-enriched water into a container at a factory, then storing, distributing and selling the product, hydrogen is lost and the concentration thereof is decreased. Further, there is a problem that equipments for injection of hydrogen and bottling are required and the cost for such equipments is high (Patent Document 2).

Further, as a method for chemically producing drinkable hydrogen-enriched water, a method in which metallic magnesium is immersed in water to generate hydrogen can be employed, and a stick-shaped product or a product having the structure of a pitcher is used (Patent Document 3). In these methods, hydrogen is generated in the state where metallic magnesium is immersed in water. These are inexpensive compared to the electrolysis method because no special apparatus is required. However, there is a problem that a reaction generating hydrogen is no longer developed because of saturation of magnesium ion in the metallic magnesium-added aqueous solution. Moreover, there is a problem that hydrogen is no longer generated because magnesium hydroxide is deposited on the surface of the metallic magnesium to cause deterioration. Therefore, in order to maintain the ability to generate hydrogen, it is required to exchange water and to chemically polish the surface of the metallic magnesium on a regular basis using grain vinegar or the like. Furthermore, there is a problem that since hydroxide ion is accumulated with the generation of hydrogen, hydrogen-enriched water has a pH of more than 10 and therefore is not appropriate for drinking.

### CITATION LIST

### Non-Patent Literature

Non-Patent Document 1: NAT Med. 2007 June; 13(6): 688-94. Epub 2007 May 7.
Non-Patent Document 2: Biochem Biophys Res Commun. 2008 Dec. 26; 377(4): 1195-8.
Non-Patent Document 3: Brain Res. 2010 Apr. 30; 1328: 152-61. Epub 2010 Feb. 19.
Non-Patent Document 4: Neuropsychopharmacology. 2009 January; 34(2): 501-8. Epub 2008 Jun. 18.
Non-Patent Document 5: Nutr Res. 2008 March; 28(3): 137-43.
Non-Patent Document 6: Neurosci Lett. 2009 Apr. 3; 453(2): 81-5. Epub 2009 Feb. 12.
Non-Patent Document 7: Biochem Biophys Res Commun. 2007 Sep. 28; 361(3): 670-4. Epub 2007 Jul. 25.
Non-Patent Document 8: Exp Biol Med (Maywood). 2009 October; 234(10): 1212-9. Epub 2009 Jul. 13.
Non-Patent Document 9: Biochem Biophys Res Commun. 2009 Nov. 27; 699(4): 651-6. Epub 2009 Sep. 17.
Non-Patent Document 10: J. Clin. Biochem. Nutr., 46, 140-9, March 2010

### Patent Literature

Patent Document 1: Japanese Patent No. 3349710
Patent Document 2: Japanese Patent No. 3606466
Patent Document 3: Japanese Patent No. 4252434
Patent Document 4: Japanese Laid-Open Patent Publication No. 2006-232785
Patent Document 5: Japanese Laid-Open Patent Publication No. 2008-201859

### SUMMARY OF THE INVENTION

### Technical Problem

The method of chemically producing reduced water (hydrogen-enriched water) using metallic magnesium is inexpensive compared to the electrolysis method because there is no need of special apparatuses or electricity expense, and the method is safe and makes little waste. However, there is a problem that a reaction generating hydrogen is no longer developed because of saturation of magnesium ions in the metallic magnesium-added aqueous solution, and there is also a problem that regardless of the presence of magnesium, a reaction generating hydrogen is no longer developed because of deterioration of the surface of the metallic magnesium. As a result, the method is disadvantageous in that the efficiency of the production of reduced water (hydrogen-enriched water) is decreased. The present invention provides a method of improving the efficiency of the hydrogen generation reaction and suppressing performance deterioration due to deterioration of the metal surface.

### Solution to Problem

The present invention is a method for producing reduced water (hydrogen-enriched water), in which hydrogen is generated in water using metallic magnesium and using, for example, a porous solid phase having ion exchange effects. Further, the present invention is a method for producing reduced water (hydrogen-enriched water) characterized in that, for example, an anode is placed in a layer obtained by mixing a solid phase having ion exchange effects with metallic magnesium to precipitate the mixture in water, and for example, current is applied to a cathode placed in the supernatant of water. The present invention is characterized in that, for example, the functional group of the solid phase that is an ion-exchange resin is a sulfonic acid group or carboxylic acid group. Moreover, in the present invention, the functional group such as a sulfonic acid group and a carboxylic acid group of the solid phase is preferably neutralized with an alkali to be in the form of a salt. Further, the present invention is characterized in that the anode to be used at the time of promoting the reaction by applying current is made of a carbon-containing material. More specifically, the present invention provides methods for producing reduced water (hydrogen-enriched water), apparatuses for producing reduced water (hydrogen-enriched water) and the like as described below.

(1) A method for producing reduced water, wherein a porous solid phase is used in a method for generating hydrogen in water using metallic magnesium.
(2) The method for producing reduced water according to item (1), wherein the solid phase has ion exchange effects.
(3) The method for producing reduced water according to item (1) or (2), wherein the solid phase has an acidic functional group.
(4) The method for producing reduced water according to any one of items (1) to (3), wherein the solid phase has a sulfonic acid group.
(5) The method for producing reduced water according to any one of items (1) to (3), wherein the solid phase has a carboxylic acid group.
(6) The method for producing reduced water according to any one of items (1) to (5), wherein the solid phase is a resin.
(7) The method for producing reduced water according to any one of items (1) to (6), wherein the solid phase is an ion-exchange resin.
(8) The method for producing reduced water according to any one of items (1) to (7), wherein the solid phase removes hydroxide generated on the surface of the metallic magnesium.
(9) The method for producing reduced water according to any one of items (1) to (8), wherein the metallic magnesium is oxidized to generate hydrogen at a cathode.
(10) The method for producing reduced water according to item (9), wherein the anode is made of a carbon-containing material.
(11) A spray apparatus for spraying reduced water produced using the method according to any one of items (1) to (10).
(12) A food product or a cosmetic product to which reduced water produced using the method according to any one of items (1) to (10) is added in the form of a liquid, a solid, powder or a paste.
(13) An apparatus for producing reduced water in which hydrogen is generated in water using metallic magnesium, wherein a porous solid phase is used.
(14) An apparatus for producing reduced water comprising electrodes, wherein metallic magnesium is oxidized to generate hydrogen at a cathode to produce the reduced water, and wherein the apparatus further comprises a solid phase which removes hydroxide generated on the surface of the metallic magnesium.
(15) The apparatus for producing reduced water according to item (13) or (14), which further has an anode made of a carbon-containing material.
(16) The apparatus for producing reduced water according to any one of items (13) to (15), which further has a coating member for coating the surface of the anode.
(17) The apparatus for producing reduced water according to any one of items (13) to (16), the apparatus having a first oxidation-reduction system and a second oxidation-reduction system, each of which comprises the anode and the cathode.
(18) An apparatus for producing reduced water in which hydrogen is generated in water using electrodes, wherein the apparatus has an anode made of a carbon-containing material.
(19) An apparatus for producing reduced water in which hydrogen is generated in water using metallic magnesium, wherein the apparatus has an anode made of a carbon-containing material.
(20) The apparatus for producing reduced water according to item (18) or (19), which further has a coating member for coating the surface of the anode.

### Advantageous Effect of the Invention

According to the present invention, for example, by mixing the porous solid phase having ion-exchange effects with metallic magnesium or the like, the saturating amount of magnesium ions in water can be increased, and the efficiency of hydrogen generation and the efficiency of the production of reduced water (hydrogen-enriched water) can be improved. In addition, the increase of the oxidation-reduction potential due to reduction of the content of hydrogen in reduced water caused by the decrease of hydrogen generation due to deterioration of the surface of the metallic magnesium can be reduced, and continuousness of the reaction can be retained well. Further, for example, the solid phase having ion-exchange effects, together with metallic magnesium, can be easily separated from reduced water (hydrogen-enriched water) by a filter, and therefore, drinkable water can be obtained. Moreover, for example, by allowing the anode to contact with the layer obtained by mixing the solid phase having ion exchange effects with metallic magnesium to precipitate the mixture in water and applying current to the cathode placed in the supernatant of water added, elution of magnesium is promoted, and the production of magnesium hydroxide on the surface of the metallic magnesium is suppressed. Furthermore, by using the carbon-containing material as the anode, hydroxide ion that is inevitably generated together with hydrogen is converted to carbon dioxide, and therefore, magnesium hydroxide precipitated on the metallic magnesium can be significantly decreased, and as a result, the efficiency of the elution of metallic magnesium can be maintained well for a long period of time.

### BRIEF DESCRIPTION OF THE DRAWINGS

FIG. 1 is a schematic view showing a method for mixing metallic magnesium with an anode to apply a current thereto.

FIG. 2 is an explanatory drawing showing changes in the concentration of dissolved hydrogen and the oxidation-reduction potential caused by serial doubling dilution of reduced water (hydrogen-enriched water).

FIG. 3 shows variation of the oxidation-reduction potential per day when adding a strong acid ion-exchange resin having a sulfonic acid group as a MR-type or gel-type carrier and metallic magnesium to water.

FIG. 4 shows variation of the oxidation-reduction potential per day when adding a strong acid ion-exchange resin having a sulfonic acid group as a MR-type carrier with the amount thereof added being changed, together with metallic magnesium to water.

FIG. 5 is an explanatory drawing showing time-dependent change in the oxidation-reduction potential of a sample, in which a strong acid ion-exchange resin having a sulfonic acid group was added together with metallic magnesium to water, and which was after use for a predetermined number of days.

FIG. 6 is an explanatory drawing showing time-dependent change in the oxidation-reduction potential when adding a strong acid ion-exchange resin having a sulfonic acid group with the amount thereof added being changed, together with metallic magnesium to water.

FIG. 7 is an explanatory drawing showing time-dependent change in the oxidation-reduction potential of a sample, in which an ion-exchange resin having a carboxylic acid group was added together with metallic magnesium to water, and which was after use for a predetermined number of days.

FIG. 8 is an explanatory drawing showing time-dependent change in the oxidation-reduction potential of a sample, in which an ion-exchange resin having quaternary ammonium base was added together with metallic magnesium to water, and which was after use for a predetermined number of days.

FIG. 9 is an explanatory drawing showing time-dependent change in the oxidation-reduction potential of a sample, in which an ion-exchange resin having tertiary amine as a functional group was added together with metallic magnesium to water, and which was after use for a predetermined number of days.

FIG. 10 shows the relationship between the material of the anode and the concentration of dissolved hydrogen or pH in the case where metallic magnesium was not added.

FIG. 11 shows the relationship between the material of the anode and the concentration of dissolved hydrogen or pH in the case where metallic magnesium was added.

FIG. 12 shows the concentration of dissolved hydrogen, pH and concentration of carbon dioxide in the case where the anode was a carbon rod.

FIG. 13 shows change in the concentration of dissolved hydrogen and pH in the case where an ion-exchange resin was added in the method of applying current at the time of a oxidation reaction of metallic magnesium.

FIG. 14 shows effects of a chemical reaction caused by metallic magnesium and electrolysis using electrodes on the concentration of dissolved hydrogen and pH.

FIG. 15 shows effects of a coating material of a carbon rod as an anode on the concentration of dissolved hydrogen and pH in the case where metallic magnesium was not added.

FIG. 16 shows effects of a coating material of a carbon rod as an anode on the concentration of dissolved hydrogen and pH in the case where metallic magnesium was added.

FIG. 17 shows the concentration of fine particles in a solution (the degree of contamination caused by carbon powder) based on the measurement of the absorbance.

FIG. 18 is a view schematically explaining an apparatus for producing reduced water (hydrogen-enriched water).

FIG. 19 is a view explaining the internal structure of the apparatus for producing reduced water (hydrogen-enriched water) in detail.

FIG. 20 shows change in the concentration of dissolved hydrogen and pH when applying current to each of two circuits (oxidation-reduction systems) of an apparatus for producing reduced water (hydrogen-enriched water).

### DESCRIPTION OF EMBODIMENTS

### 1. Anode

In the method for producing reduced water (hydrogen-enriched water) and the apparatus for producing reduced water (hydrogen-enriched water) of the present invention, hydrogen is generated in water using metallic magnesium. In a preferred embodiment, by an oxidation-reduction reaction in water, preferably, a metal such as magnesium is oxidized at an anode and hydrogen is generated at a cathode, though the present invention is not particularly limited thereto. The size and form of the metallic magnesium to be used are not particularly limited, but a granular or flake-like material having a size of preferably 0.1 mm to 50 mm, and more preferably 1 mm to 5 mm is desirable. Regarding the anode to be used in the oxidation-reduction reaction, the type of a material to be used for the anode and the structure of the apparatus are not particularly limited, but the anode is preferably formed of a metal such as stainless steel, copper, aluminium, iron, gold, platinum, silver and titanium, or a carbon-containing material. The anode formed of the carbon-containing material is particularly excellent on the point that it converts hydroxide ion produced with the generation of hydrogen into carbonate ion, thereby preventing extreme increase of the pH value in the water system. For the anode formed of the carbon-containing material, for example, a carbon-containing solid phase such as a carbon rod, a carbon-containing resin and resin penetrated carbon may be used.

The weight of a material to be used as the anode is not particularly limited, but is preferably in the range of from 0.1 g to 1 kg, and more preferably in the range of from 1 g to 50 g. The shape of the material to be used as the anode is not particularly limited, but it is preferably in the shape of a rod, and more preferably in the shape of a column.

### 2. Solid Phase

In the method for producing reduced water (hydrogen-enriched water) and the apparatus for producing reduced water (hydrogen-enriched water) of the present invention, a porous solid phase is used. The solid phase preferably removes hydroxide generated on the surface of the metallic magnesium, i.e., magnesium hydroxide or the like. By using such a solid phase, particularly by using the solid phase in contact with the anode, coating of magnesium hydroxide or the like, which has low solubility in water, on the surface of the metallic magnesium is prevented, and accordingly, more magnesium ions can be dissolved in water. Moreover, the solid phase is preferably ionically-bonded with dissolved magnesium ions. This increases the solubility of magnesium in water. By using such a solid phase, a reaction that generates hydrogen is continued for a long period of time in good conditions.

### 2. (1) Method for Producing a Solid Phase Having Ion Exchange Effects

Materials of the solid phase and the type of a functional group contained in the solid phase are not particularly limited. For example, when adding an ion-exchange resin to water together with the metallic magnesium, the effect of increasing the amount of dissolved hydrogen is exerted, but more preferably, a cation-exchange resin is used. The functional group of the cation-exchange resin is not particularly limited as long as it has a negative charge in water, but preferably, a sulfonic acid group, a carboxylic acid group or the like is used. More preferably, a sulfonic acid group is used. When the cation-exchange resin is directly used, hydrogen is excessively generated temporarily due to the reaction between an acid of the functional group and the metallic magnesium, and therefore, for example, it is desirable to use a cation-exchange resin which formed a salt of an acidic functional group, but there is no limitation thereon. The neutralization method for forming a salt of an acidic functional group is not particularly limited, but for example, a salt is formed using sodium hydroxide.

Thus, as the solid phase, a porous ion-exchange resin, in particular, a cation-exchange resin having an acidic functional group such as a sulfonic acid group and a carboxylic acid group is preferably used. In particular, as described below, a “macroporous” resin, which has many small holes (pores) of less than 2 nm, or a “macroporous” resin, which has many small holes (pores) of more than 50 nm in the inside of the substance, can be used. In addition, a “mesoporous” resin, which has holes having a size midway between them, can also be used. Moreover, a non-porous solid phase can also be used.

### 2. (2) Utilization Form of the Solid Phase

The total exchange capacity of the solid phase is not particularly limited, but is preferably 0.1 eq (equivalent)/L−R (volume of resin after swelling (L)) or more, and more preferably 1.0 eq (equivalent)/L−R (volume of resin after swelling (L)) or more. The amount of the resin to be added as the solid phase is not particularly limited, but is preferably 0.2 ml to 500 ml per 1 g, and more preferably 2 ml to 10 ml per 1 g of the metallic magnesium when converted to the volume of the swelled resin.

Further, the solid phase can be used with the metallic magnesium being mixed therewith. In this regard, for example, the mixing ratio (weight ratio) between the solid phase that is a cation-exchange resin (dry weight) and the metallic magnesium is preferably 1:10 to 25:1, and more preferably 1:1 to 5:1.

### 3. Cathode

The type and form of a material to be used for a cathode are not particularly limited. As the cathode, a metal such as stainless steel, copper, aluminium, iron, gold, platinum, silver and titanium, or a carbon-containing solid phase such as a carbon rod, a carbon-containing resin and resin penetrated carbon is preferably used, and more preferably, stainless steel is used.

### 4. Coating Member

When a carbon-containing material is used for the anode and hydroxide ion is converted into carbon dioxide at the anode as described above, carbon powder may be generated to contaminate water. In order to prevent this, it is preferred to coat the surface of the anode with a coating member which blocks passing of carbon powder. The coating member is not particularly limited, but the carbon-containing anode is preferably coated with a film, a paper, a fabric or a membrane, and more preferably coated with a porous film-like filter such as a resin membrane filter, a glass fiber filter, a cellophane, a filter paper or the like, thereby preventing contamination of water. Note that it is preferred that the coating member can allow passage of water, hydroxide ion, carbon dioxide and carbonate ion.

### 5. Oxidation-Reduction System

The apparatus for producing reduced water (hydrogen-enriched water) preferably has a plurality of oxidation-reduction systems, each of which contains electrodes. As the electrodes, the above-described anode and cathode can be used. In the oxidation-reduction system, for example, a case for separating the anode and the solid phase from the outside may be provided. This case is formed of, for example, a non-conducting substance such as plastic. A hole is formed in the case, and it is preferred to cover the hole with a sheet-like member or the like which allows selective passing of water. The sheet-like member is not particularly limited, but for example, a fabric, a filter paper, a membrane, a paper, a film or the like is preferably used, and nylon mesh is more preferably used.

By providing a plurality of oxidation-reduction systems in a single apparatus for producing reduced water, the current and voltage at each of the systems (circuits) can be independently adjusted, and the concentration of dissolved hydrogen and pH of the reduced water (hydrogen-enriched water) can be finely adjusted. Further, the shape of the oxidation-reduction systems is, for example, tubular, but there is no limitation thereon.

### 6. Water

In the present invention, the type of water to be used for the oxidation-reduction reaction is not particularly limited, but preferably, tap water, well water, river water, lake water, seawater, mineral water, distillated water or reverse osmotic water is used, and more preferably, tap water, mineral water or the like is used. The amount of water to be added is not particularly limited, but for example, it is preferably 0.1 ml to 1 L per 1 g, and more preferably 4 ml to 20 ml per 1 g of the metallic magnesium. The pH of the reaction solution is not particularly limited, but is preferably in the range of from 3 to 14, and more preferably in the range of from 7 to 12. The oxidation-reduction potential after the reaction progress is not particularly limited, but is in the range of from −800 mV to 500 mV, and preferably in the range of from −300 mV to −10 mV. The amount of dissolved hydrogen after the reaction progress is not particularly limited, but is in the range of from 0.001 to 1.6 wt ppm, and preferably in the range of from 0.1 to 1.2 wt ppm. Note that in this specification, water containing hydrogen in an amount of 0.005 wt ppm or more is defined as hydrogen-enriched water. However, this does not mean that methods and apparatuses for producing reduced water containing hydrogen in an amount of less than 0.005 wt ppm are excluded from the present invention.

Further, a buffer, an oxidant, a reducing agent, an acid, an alkali, a salt, a sugar, an adsorbent, etc. can be used according to need by being mixed with the water for the oxidation-reduction reaction, and in this case, the type of each substance is not particularly limited.

### 7. Reaction of Metallic Magnesium

The metallic magnesium reacts with water to generate hydrogen and magnesium hydroxide. The chemical formula of the oxidation-reduction reaction is shown below.

Mg+2H₂O→Mg(OH)₂+H₂ [Chemical formula 1]

The filtration method for removing the metallic magnesium and the solid phase from water after the reaction is not particularly limited, but a filter such as a non-woven fabric can be used. For example, by utilizing a solid phase having ion exchange effects, not only a natural chemical reaction of these materials in water, but also a chemical reaction to which electricity is applied can be promoted. The type of current is not particularly limited, but direct current is preferably used.

### 8. Utilization of Reduced Water

The reduced water (hydrogen-enriched water) produced by the above-described production method is, for example, put in a spray apparatus and used by being sprayed. Further, the reduced water (hydrogen-enriched water) is added to a food product or cosmetic product directly in the form of a liquid, or after processed into the form of a solid, powder or a paste.

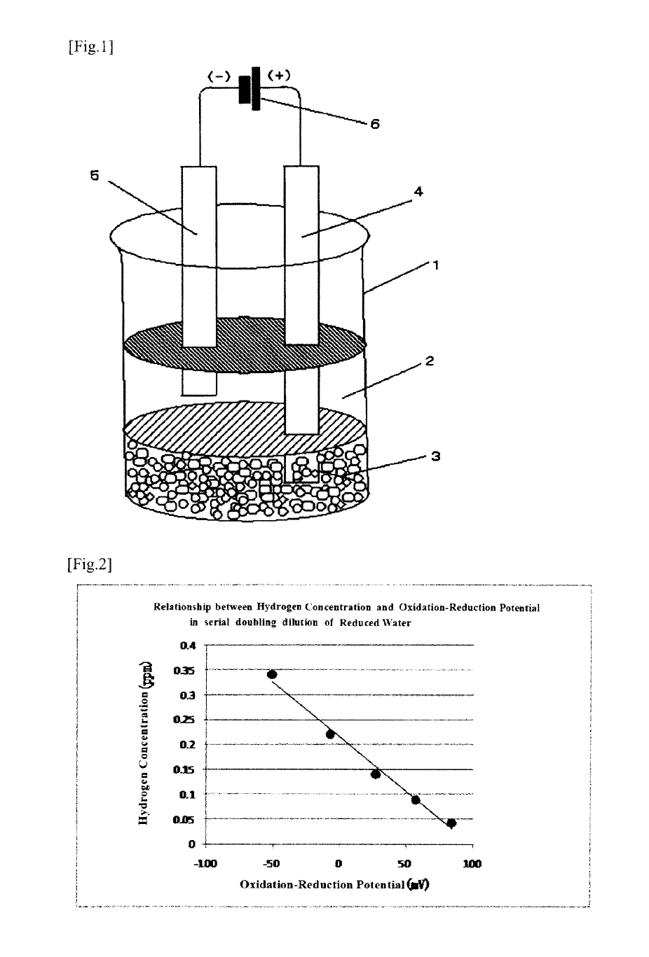

A schematic view of the apparatus for producing reduced water (hydrogen-enriched water) of the present invention is shown in FIG. 1. But the present invention is not limited by this schematic view. To a beaker 1, water 2 and a mixture 3 of a solid phase having ion exchange effects and metallic magnesium are added. Further, an anode 4 is contacted with the mixture 3 of the solid phase having ion exchange effects and metallic magnesium, which has been precipitated to provide a layer, and a cathode 5 is placed in water so as not to be in contact with the mixture 3 of the solid phase having ion exchange effects and metallic magnesium. An electric current is passed through the apparatus using a DC power source 6.

The voltage to be applied is not particularly limited, but is preferably in the range of from 0.1 V to 1000 V, and more preferably in the range of from 3 V to 100 V. The current to be passed through is not particularly limited, but is preferably in the range of from 0.1 mA to 1000 A, and more preferably in the range of from 5 mA to 400 mA. The reduced water (hydrogen-enriched water) produced can be used directly or in the form of a spray. The reaction container is not particularly limited, but a stick, a cup, a tank, a water server, an exchangeable cassette or the like can be used as the reaction container. The obtained water is directly drinkable, and alternatively, it can be formed into a liquid, a solid, powder, a paste or the like to be used as a food product or cosmetic product.

The aforementioned “ion” refers to an electrically-charged atom or electrically-charged group of atoms. It exists in a plasma such as an ionosphere, an electrolytic aqueous solution, a substance having ionic bond property such as an ionic crystal, etc.

The aforementioned “ion exchange” refers to a phenomenon or ability shown by a certain type of substance, in which the substance takes in an ion contained in an electrolyte solution with which the substance is contacted and releases a different type of ion had by the substance instead, thereby carrying out replacement of the ions.

The aforementioned “resin” refers to a non-volatile solid or semisolid substance secreted from bark.

Alternatively, it refers to a substance having characteristics very similar to those of natural resin, which has been successfully synthesized with the development of organic chemistry.

The aforementioned “ion-exchange resin” is a kind of synthetic resin and has a structure, which ionizes as an ionic group, at a portion of the molecular structure. It exerts ion exchange effects on ions in a solvent such as water, but the behavior thereof depends on selectivity toward ions. The ion-exchange resin is roughly classified into a cation-exchange resin and an anion-exchange resin based on characteristics of the ionic group, and classified into strong acid, weak acid, strong base and weak base based on dissociation property thereof.

The aforementioned “functional group” is classification of atomic groups in which attention is given to chemical attributes and chemical reactivities of substances, and each shows a specific physical property and chemical reactivity. The term refers to a group of atoms which gives chemical characteristics to a compound.

The aforementioned “total exchange capacity” refers to a total amount of ions which can be held by a resin having a certain amount of functional groups.

The aforementioned “equivalent” is a concept expressing a quantitative proportional relationship in a chemical reaction. One of typical examples is molar equivalent that expresses the ratio of the amount of a substance. As the unit thereof, Eq is used.

The aforementioned “neutralization” means that an acid is mixed with a base to allow them to mutually counteract the other's characteristics and to produce water and salt.

The aforementioned “swelling” means that water or the like is added to an ion-exchange resin to be sufficiently absorbed to expand the resin. It is carried out before using the ion-exchange resin.

The aforementioned “oxidation-reduction” refers to a chemical reaction in which electrons are exchanged among atoms, ions or compounds in the process of generating a product from a reactant.

The aforementioned “porous” refers to a state of having many small holes (pores) in the inside of a substance, such holes being had by, for example, a substance that plays a role in taking in and adsorbing to molecules, such as an adsorbent typified by activated carbon.

The aforementioned “microporous” generally refers to a state of having many small holes (pores) of less than 2 nm in the inside of a substance.

The aforementioned “macroporous” generally refers to a state of having many small holes (pores) of more than 50 nm in the inside of a substance.

The aforementioned “mesoporous” generally refers to a state of having many small holes (pores) of more than 2 nm and less than 50 nm in the inside of a substance.

The aforementioned “oxidation-reduction potential” refers to a potential (correctly, electrode potential) which is generated at the time of exchanging electrons in an oxidation-reduction reaction system. It is also a measure for quantitatively evaluating ease of release or receipt of electrons by a substance. As the unit thereof, volt is used.

The aforementioned “buffer” refers to a solution having the buffering effect. Usually, when just saying “buffer”, it means a solution having the buffering effect on the concentration of hydrogen ion.

The aforementioned “non-woven fabric” refers to a fabric which is made by bonding or intertangling fibers by thermal/mechanical or chemical action without weaving thread obtained by twisting fibers as in the case of usual fabrics.

The aforementioned “reverse osmotic water” refers to water passed through a kind of filtration membrane, which has characteristics in that water can be passed through but impurities other than water such as ions and salts cannot be passed through.

The aforementioned “carbon-containing resin” refers to a product produced by kneading carbon powder into a resin and molding the mixture. It has conductivity, and also has characteristics such as excellent strength.

The aforementioned “resin penetrated carbon” refers to a product produced by allowing resin to penetrate from the surface of a solid phase such as a carbon rod. It has conductivity, and also has characteristics such as excellent strength.

### EXAMPLES

Hereinafter, working examples of the present invention will be described, but the present invention is not limited to these examples. Terms used in experiments below will be described.

The “gel” is a material in which liquid is trapped into a net of polymers. A gel in which polymers are just closely positioned and weakly bonded is a physical gel, and typical examples thereof include jelly and agar. A gel in which polymers are chemically bonded is a chemical gel, and examples thereof include water-absorbing materials and contact lenses. The “polymer” refers to a compound which is produced when a plurality of unit structures (monomers) are polymerized (bound to form a chain-like or net-like structure). Therefore, the polymer is generally a macromolecular organic compound. The “copolymer” particularly refers to a polymer consisting of 2 or more types of unit structures (monomers). The “carrier” refers to a substance that serves as a base for fixing a substance showing adsorption and catalyst activity. It is desirable that the carrier itself is chemically stable and does not inhibit desired operation. The “hydrogen-enriched water” refers to water containing a large amount of hydrogen molecules (hydrogen gas). Hydrogen molecules do not become hydrogen ions when dissolved in water, and therefore, the pH is not directly affected by hydrogen molecules. The “electrolysis” is a method in which the voltage is applied to a compound to cause an oxidation-reduction reaction electrochemically, thereby chemically decomposing the compound. In Japanese, “denki-bunkai (electrolysis)” is abbreviated to “den-kai”. The “electrolytic barrier membrane” refers to a porous partition wall placed between the anode and the cathode at the time of electrolysis in order to prevent mixing and side reaction of reaction products at the anode and the cathode.

### Example 1

The amount of hydrogen generation in water was examined using metallic magnesium (Chuo-Kosan Co., Ltd., CM-CLIMP (registered trademark)), Amberlite 200CT NA (registered trademark) (Organo Corporation, ion-exchange resin) and Amberlite IR120B NA (registered trademark) (Organo Corporation, ion-exchange resin). The inside of an ordinary gel-type ion-exchange resin has a net-like structure (microporosity), which is determined by the degree of cross-linking of molecules, meanwhile an MR-type ion-exchange resin has both microporosity and a physical pore (macroporosity), which is distinguished therefrom.

200CT NA (registered trademark) is a strong acid ion-exchange resin having the MR structure of styrene-divinylbenzene copolymer as a carrier, and sulfonic acid is bound thereto as a functional group.

IR120B NA (registered trademark) has a similar structure, but a carrier thereof has a gel structure.

Further, each of 200CT NA (registered trademark) and IR120B NA (registered trademark) has been neutralized with sodium hydroxide as a salt at the time of use.

Note that metals other than magnesium such as iron and zinc can also be used for hydrogen generation, but from the viewpoint of reactivity, efficiency of hydrogen generation and safety, metallic magnesium is particularly suitable.

To a 100 ml beaker, 5 g of flake-like metallic magnesium (maximum length: about 4 mm) was added. 100 ml of tap water was added thereto, and the beaker was covered with aluminum foil and left overnight. The reduced water (hydrogen-enriched water) obtained was subjected to serial doubling dilution with tap water, and the relationship between the concentration of dissolved hydrogen and the oxidation-reduction potential was examined (see FIG. 2). The concentration of dissolved hydrogen was measured using a dissolved hydrogen meter (UP Corporation, model number: ENH-1000), and the oxidation-reduction potential was measured using a digital ORP meter (Mother Tool Co., Ltd., model number: YK-23RP). As a result, it was confirmed that the concentration of dissolved hydrogen and the oxidation-reduction potential have a linear relationship. Reduced water prepared by reacting metallic magnesium with water is hydrogen-enriched water, and generation of hydrogen can be indirectly detected by measuring the oxidation-reduction potential.

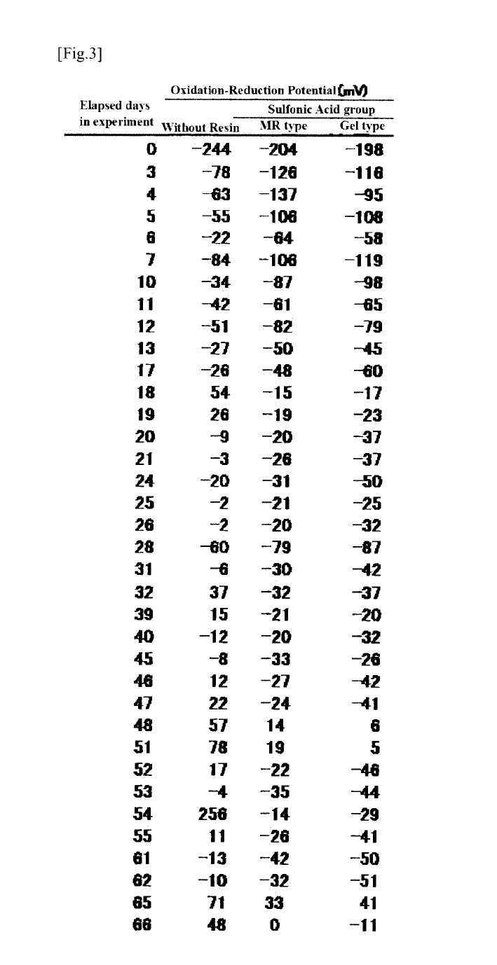

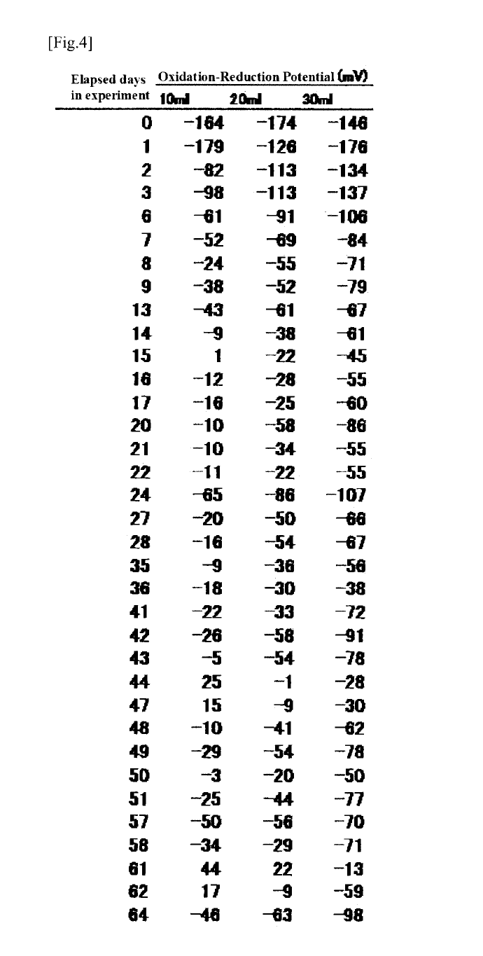

Each of the ion-exchange resins was swelled and washed with tap water. After that, 20 ml of resin was put into a 100 ml beaker, and 5 g of metallic magnesium was added thereto, and the amount was adjusted to 100 ml finally using tap water. As a comparative control, a sample in which only 5 g of metallic magnesium was added was prepared. On and after the day after the reaction initiation date, water exchange was carried out about 5 times at about 1-hour intervals every day. At the time of water exchange, supernatant in the beaker was removed, 100 ml of tap water was newly added and mixed, supernatant of the mixture was removed, and tap water was newly added again to adjust the amount of the mixture to 100 ml finally. Further, 30 minutes to 1 hour after the first water exchange every morning, the oxidation-reduction potential was measured. In all the measurements for 66 days, regardless of the type of the carrier, the sample in which a strong acid cation-exchange resin having sulfonic acid as a functional group was put showed a significantly low oxidation-reduction potential and strong reducing property compared to the sample containing only metallic magnesium. Results are shown in FIG. 3.

### Example 2

In a manner similar to that in Example 1, the relationship between the amount of resin and the oxidation-reduction potential was examined using metallic magnesium and Amberlite 200CT NA (registered trademark) that is a cation-exchange resin in which sulfonic acid as a functional group is bound to a carrier. Each of the ion-exchange resins was swelled and washed with tap water. After that, 10, 20 or 30 ml of resin was put into a 100 ml beaker, and 5 g of metallic magnesium was added thereto, and the amount was adjusted to 100 ml finally using tap water. On and after the day after the reaction initiation date, water exchange was carried out about 5 times at about 1-hour intervals every day. Further, 30 minutes to 1 hour after the first water exchange every morning, the oxidation-reduction potential was measured. In most of the measurements for 64 days, the sample in which 30 ml of the ion-exchange resin was put showed a significantly low oxidation-reduction potential and strong reducing property compared to the other samples. Similarly, the sample in which 10 ml of the ion-exchange resin was put showed a significantly high oxidation-reduction potential and weak reducing property compared to the other samples. By increasing the amount of the cation-exchange resin to be added, the improvement of the efficiency of hydrogen generation was shown, and strong reducing property was shown. Results are shown in FIG. 4.

### Example 3

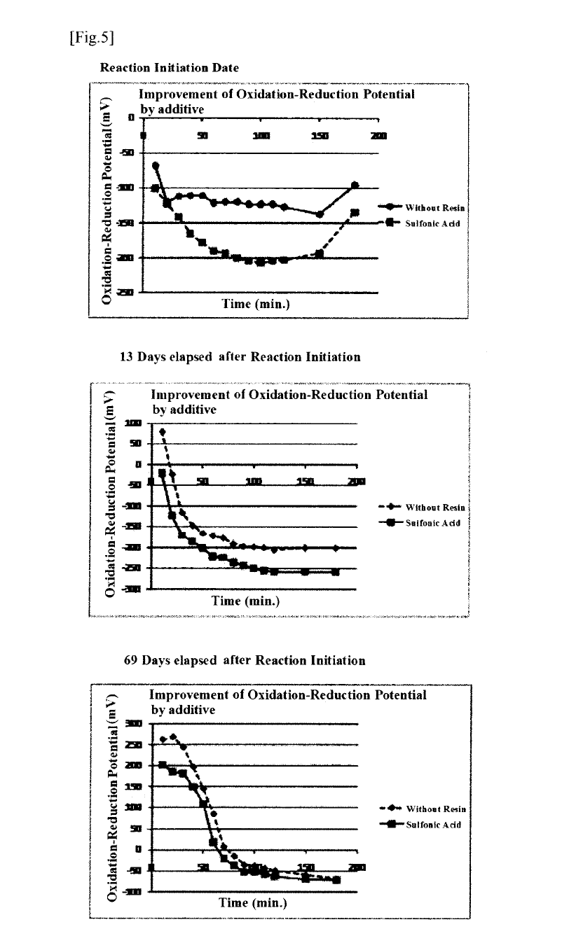

In a manner similar to that in Example 1, the experiment was carried out using metallic magnesium and Amberlite 200CT NA (registered trademark) that is a cation-exchange resin in which sulfonic acid as a functional group is bound to a carrier. 20 ml of the cation-exchange resin was put into a 100 ml beaker, 5 g of metallic magnesium was added thereto, and the amount was adjusted to 100 ml finally using tap water. As a comparative control, a sample in which only metallic magnesium was added was prepared. On and after the day after the reaction initiation date, water exchange was carried out about 5 times at about 1-hour intervals every day. The measurement was carried out on the reaction initiation date, after a lapse of 13 days, and after a lapse of 69 days. The measurement was carried out using the sample in which only metallic magnesium was put and the sample in which metallic magnesium and the cation-exchange resin having sulfonic acid as a functional group were put after a lapse of predetermined days. Supernatant in the beaker was removed, 100 ml of tap water was newly added and mixed, supernatant of the mixture was removed, and tap water was newly added again to adjust the amount of the mixture to 100 ml finally, and thus the measurement was started. The oxidation-reduction potential after 10 to 180 minutes was measured. Results are shown in FIG. 5.

In the experiment using the samples on the reaction initiation date, the oxidation-reduction potential of the sample containing only metallic magnesium decreased to about −140 mV, and the oxidation-reduction potential of the sample to which the ion-exchange resin having a sulfonic acid group was added decreased to −210 mV. In the experiment using the samples after a lapse of 13 days, the oxidation-reduction potential of the sample containing only metallic magnesium decreased to about −200 mV, and the oxidation-reduction potential of the sample to which the cation-exchange resin having a sulfonic acid group was added decreased to −260 mV. In the experiment using the samples after a lapse of 69 days, in both the sample containing only metallic magnesium and the sample to which the ion-exchange resin having a sulfonic acid group was added, the oxidation-reduction potential decreased to about −70 mV. The effect of improving the efficiency of hydrogen generation exerted by the cation-exchange resin having sulfonic acid as a functional group was maintained from the reaction initiation date, but the effect almost disappeared after a lapse of 69 days.

### Example 4

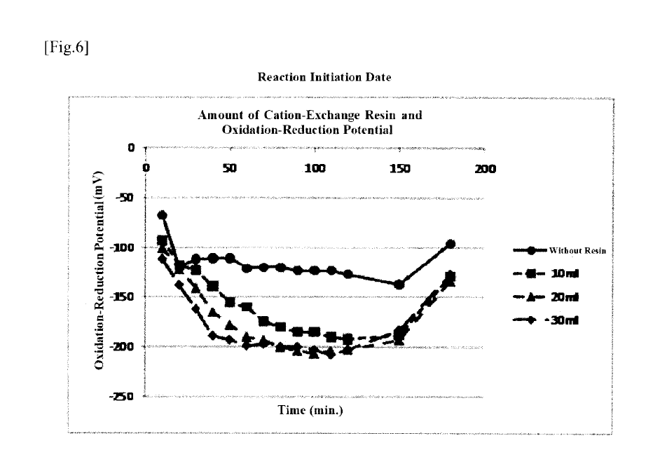

In a manner similar to that in Example 1, the relationship between the amount of resin and the oxidation-reduction potential was examined using metallic magnesium and Amberlite 200CT NA (registered trademark) that is a cation-exchange resin in which sulfonic acid as a functional group is bound to a carrier. 10 ml, 20 ml or 30 ml of a new cation-exchange resin was put into a 100 ml beaker, 5 g of metallic magnesium was added thereto, and the amount was adjusted to 100 ml finally using tap water. As a comparative control, a sample in which only metallic magnesium was added was prepared. The oxidation-reduction potential after 10 to 180 minutes was measured. Results are shown in FIG. 6. The oxidation-reduction potential of the sample containing only metallic magnesium was about −140 mV, but when the cation-exchange resin having a sulfonic acid group was added, the oxidation-reduction potential was about −200 mV. The larger the amount of the resin added was, the more the oxidation-reduction potential decreased. By the addition of the cation-exchange resin having a sulfonic acid group, the oxidation-reduction potential significantly decreased and the efficiency of hydrogen generation was improved.

### Example 5

In a manner similar to that in Example 1, metallic magnesium and Amberlite 200CT NA (registered trademark) were used. In addition, Amberlite IRC76 (registered trademark) (Organo Corporation, weak acid cation-exchange resin), Amberlite IRA400J C1 (registered trademark) (Organo Corporation, strong base anion-exchange resin) and Amberlitc IRA67 (registered trademark) (Organo Corporation, weak base anion-exchange resin) were newly used to examine the oxidation-reduction potentials.

In 200CT NA (registered trademark), sulfonic acid as a functional group is bound to a carrier. In IRC76 (registered trademark), carboxylic acid as a functional group is bound to a carrier. In IRA400J C1 (registered trademark), quaternary ammonium base as a functional group is bound to a carrier. Further, in IRA67 (registered trademark), tertiary amine as a functional group is bound to a carrier. 200CT NA (registered trademark) has a styrene-divinylbenzene copolymer as a carrier. IRC76 (registered trademark) has a polyacrylic copolymer as a carrier. IRA400J C1 (registered trademark) has a styrene-divinylbenzene copolymer as a carrier. IRA67 (registered trademark) has an acrylic-divinylbenzene copolymer as a carrier. Further, each of 200CT NA (registered trademark) and IRA400J C1 (registered trademark) has been neutralized with sodium hydroxide and hydrochloric acid as a salt at the time of use. In the case of IRC76 (registered trademark) and IRA67 (registered trademark), 20 ml of the swelled resin was put into a 100 ml beaker, 100 ml of tap water was put therein, sodium hydroxide and hydrochloric acid were added thereto to obtain 1N solution, and the neutralization operation was performed overnight. Each of the samples was washed well with tap water, and the pH thereof was changed from neutral to weak alkaline using hydrochloric acid and sodium hydroxide. Finally, 5 g of metallic magnesium and tap water were added to each of the samples to adjust the final amount to 100 ml, and then the experiment was started.

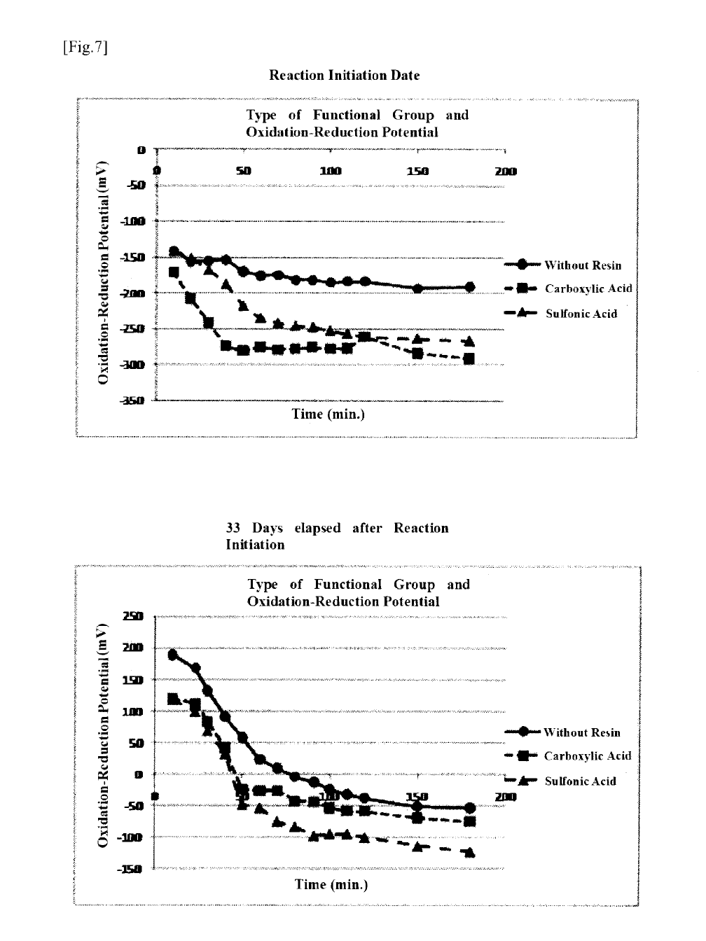

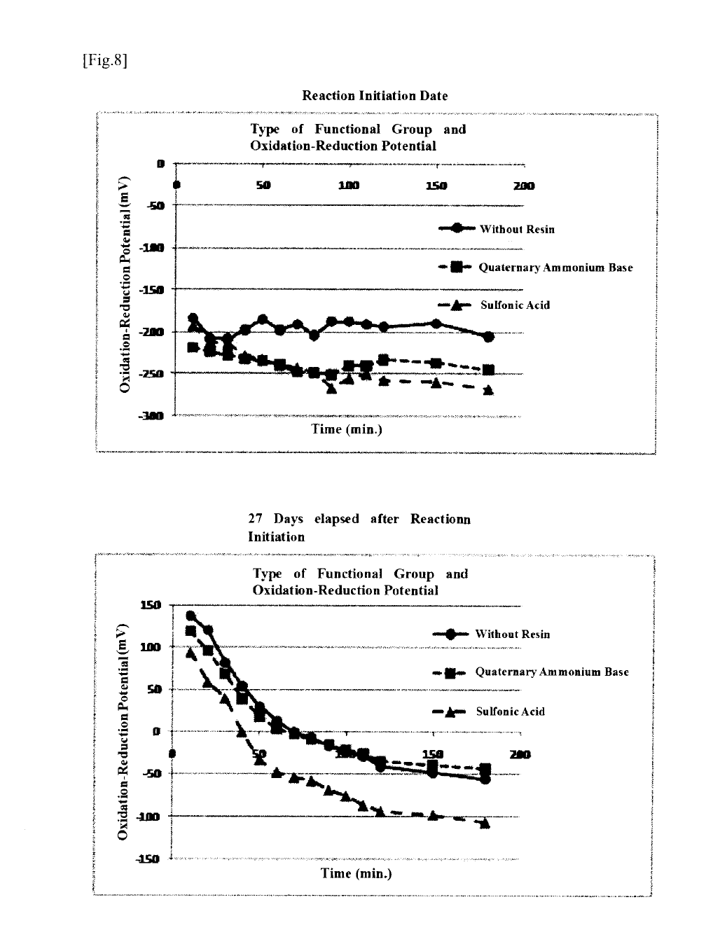

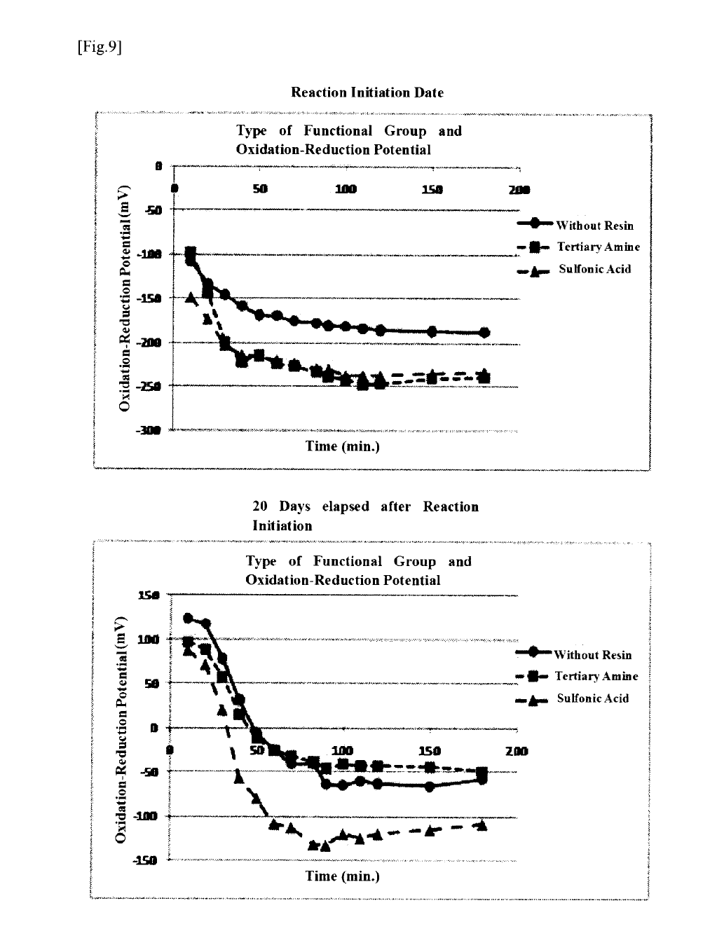

On and after the day after the reaction initiation date, water exchange was carried out about 5 times at about 1-hour intervals every day. The sample of the ion-exchange resin having carboxylic acid as a functional group was measured on the reaction initiation date and after a lapse of 33 days. The sample of the ion-exchange resin having quaternary ammonium base as a functional group was measured on the reaction initiation date and after a lapse of 27 days. The sample of the ion-exchange resin having tertiary amine as a functional group was measured on the reaction initiation date and after a lapse of 20 days. In each case, the oxidation-reduction potential after 10 to 180 minutes was measured. Results are shown in FIGS. 7-9. On the reaction initiation date, the oxidation-reduction potentials of the sample of the ion-exchange resin having quaternary ammonium base as a functional group and the sample of the ion-exchange resin having tertiary amine as a functional group were nearly equal to the oxidation-reduction potential of the sample of the ion-exchange resin having sulfonic acid as a functional group. However, after a lapse of about 1 month, the oxidation-reduction potentials were equal to the oxidation-reduction potential of the sample containing only metallic magnesium. On the reaction initiation date, the oxidation-reduction potential of the sample of the ion-exchange resin having carboxylic acid as a functional group was lower than the oxidation-reduction potential of the sample of the ion-exchange resin having a sulfonic acid group as a functional group. However, after a lapse of about 1 month, the oxidation-reduction potential was at the level intermediate between that of the sample of the ion-exchange resin having a sulfonic acid group as a functional group and that of the sample containing only metallic magnesium. The ion-exchange resin having carboxylic acid as a functional group showed increased reduction action.

### Example 6

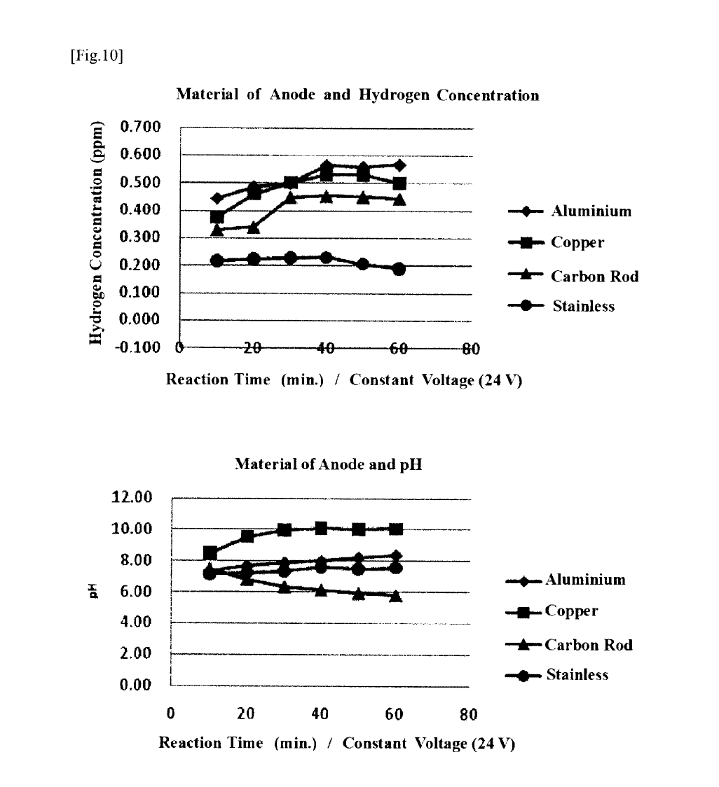

100 ml of tap water was added to a 100 ml beaker. As a cathode, stainless steel (2 cm×5 cm, thickness: 0.3 mm) (Kyuho Corporation, SUS430) was used fixedly. As an anode, stainless steel (Kyuho Corporation, SUS430), copper (Kyuho Corporation) or aluminium (Kyuho Corporation) (2 cm×5 cm, thickness: 0.3 mm), or a carbon rod having a diameter of 9.5 mm and a length of 10 cm (C-TASK Co., Ltd.) was used. Thus, comparative experiments were carried out. Using a power source (Amersham Biosciences, Power Supply EPS301), direct current was passed through to perform electrolysis. The voltage was fixed to 24 V, which is frequently used for home electronics. After applying current for 1 hour, the concentration of dissolved hydrogen and pH were measured. The concentration of dissolved hydrogen was measured using a dissolved hydrogen meter (UP Corporation, model number: ENH-1000). The pH was measured using a pH meter (Sato Keiryoki Mfg. Co., Ltd. SK-620PH). Results are shown in FIG. 10.

After the reaction for 1 hour, in the experiment using stainless steel as the anode, the concentration of hydrogen generated was 0.190 ppm, which was the lowest value, and in the experiment using the carbon rod as the anode, the concentration was 0.440 ppm, and the concentration in the experiment using aluminium was 0.570 ppm, which was the highest value. The pH in the experiment using the carbon rod as the anode was 5.79, which was the lowest value, and the pH in the experiment using copper as the anode was 10.07, which was the highest value. Further, regarding contamination of water after electrolysis, strong coloring of water, white suspended solids and white precipitate were observed in the experiments using copper, aluminium or stainless steel as the anode. In addition, after the current was fixed to 60 mA and applied for 1 hour, the concentration of dissolved hydrogen and pH were measured. As a result, similar results were obtained.

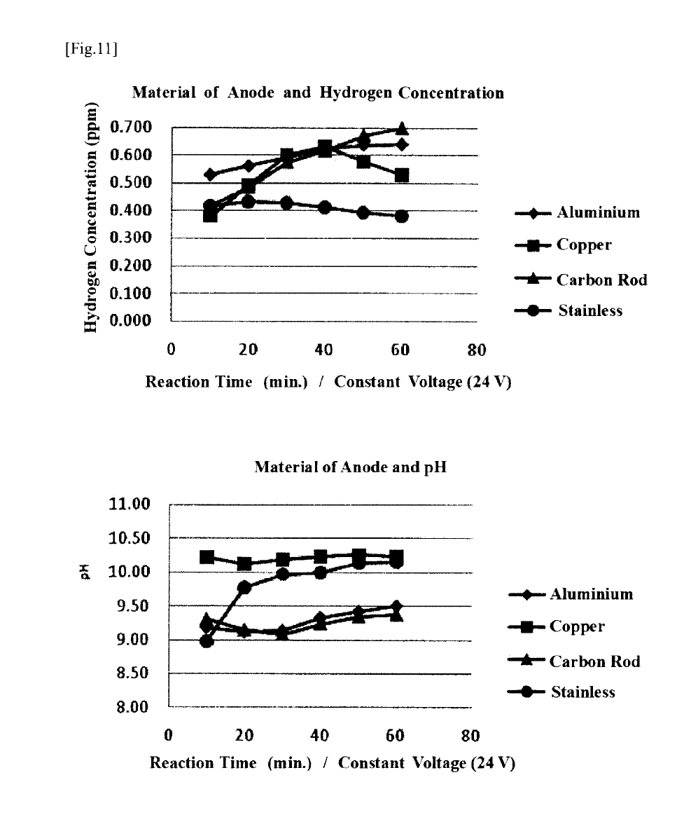

Next, metallic magnesium that is the same as that used in Example 1 was added to a 100 ml beaker as an experimental apparatus, and 100 ml of tap water was added thereto. As a cathode, stainless steel was used fixedly, and as an anode, stainless steel, copper, aluminium or a carbon rod was used, and thus comparative experiments were carried out. FIG. 1 is a schematic view of the experiments. To a beaker 1, 10 g of metallic magnesium 3 was added, and tap water 2 was added thereto to adjust the amount to 100 ml. An anode 4 was contacted with the metallic magnesium 3, which had been precipitated to provide a layer, and a cathode 5 was placed in water so as not to be in contact with the metallic magnesium 3. An electric current was passed through the apparatus using a DC power source 6. The voltage was fixed to 24 V, which is frequently used for home electronics. After applying current for 1 hour, the concentration of dissolved hydrogen and pH were measured. Results are shown in FIG. 11.

In the experiment using stainless steel as the anode, the concentration of dissolved hydrogen was 0.383 ppm, which was the lowest value. In the experiment using the carbon rod as the anode, the concentration was 0.699 ppm, which was the highest value. The pH in the experiment using copper as the anode was 10.24, which was the highest value, and the pH in the experiment using the carbon rod was 9.38, which was the lowest value. Further, regarding contamination of water after electrolysis, strong coloring of water, white suspended solids and white precipitate were observed in the experiments using copper, aluminium or stainless steel as the anode. When performing electrolysis at a constant voltage of 24 V in the state where the metallic magnesium was contacted with the carbon rod as the anode, a drinkable water having a high concentration of dissolved hydrogen and a pH of less than 10 with low levels of coloring of water, white suspended solids and white precipitate was successfully obtained.

### Example 7

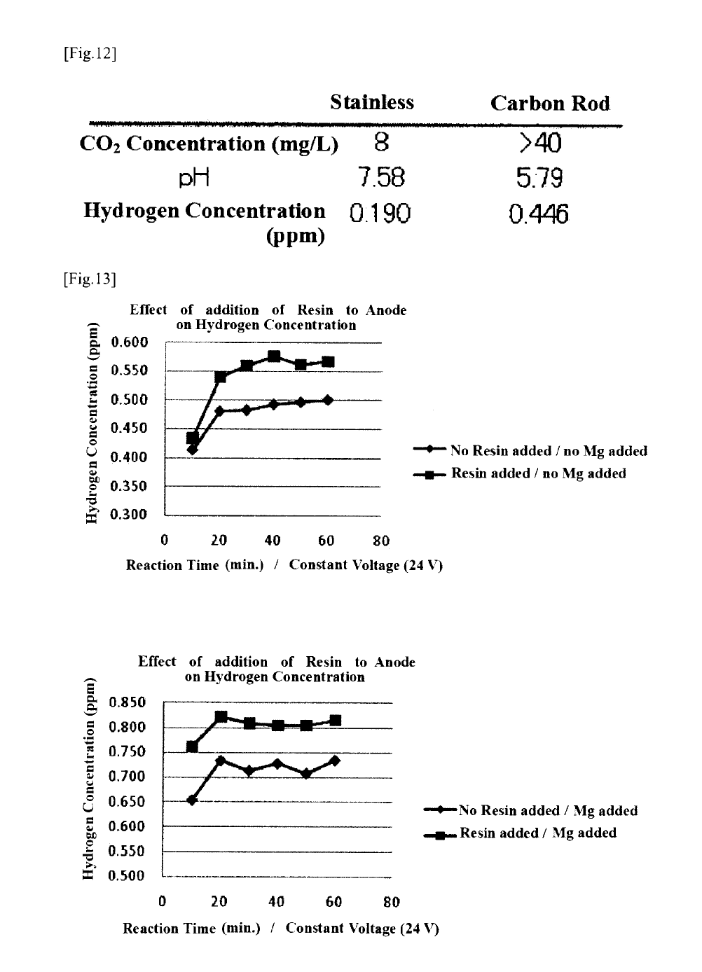

100 ml of tap water was added to a 100 ml beaker. As a cathode, stainless steel (2 cm×5 cm, thickness: 0.3 mm) was used fixedly. As an anode, stainless steel (2 cm×5 cm, thickness: 0.3 mm) or a carbon rod having a diameter of 9.5 mm and a length of 10 cm was used. Thus, comparative experiments were carried out. In every experiment, direct current was passed through to perform electrolysis using a power source. The voltage was fixed to 24 V, which is frequently used for home electronics. After applying current for 1 hour, the concentration of dissolved hydrogen, the concentration of carbon dioxide and pH were measured. The concentration of dissolved hydrogen was measured using a dissolved hydrogen meter (UP Corporation, model number: ENH-1000). The pH was measured using a pH meter. The concentration of carbon dioxide was measured using a dissolved carbon dioxide detection kit (Tetra Japan, Tetra Test (registered trademark)). Results are shown in FIG. 12. The concentration of dissolved hydrogen in the experiment using stainless steel as the anode was 0.190 ppm, and the concentration in the experiment using the carbon rod as the anode was 0.446 ppm. Thus, the concentration of dissolved hydrogen in the experiment using the carbon rod was higher. Further, in the experiment using stainless steel, the solubility of carbon dioxide in water was low (8 g/ml) and the pH was high (7.58). Meanwhile, in the experiment using the carbon rod, the solubility of carbon dioxide in water was 40 mg/ml or more and the pH was significantly lowered (5.79).

### Example 8

As an anode, a carbon rod having a diameter of 9.5 mm and a length of 10 cm was used, and as a cathode, stainless steel (2 cm×5 cm, thickness: 0.3 mm) was used. The experiment was carried out using 10 g of metallic magnesium that is the same as that used in Example 1 and 20 ml of Amberlite 200CT NA (registered trademark) that is an ion-exchange resin having a sulfonic acid group as a functional group. FIG. 1 is a schematic view thereof. To a beaker 1, a mixture 3 of the ion-exchange resin and the metallic magnesium was added, and tap water 2 was added thereto to adjust the amount to 100 ml. An anode 4 was contacted with the mixture 3 of the ion-exchange resin and the metallic magnesium, which had been precipitated to provide a layer, and a cathode 5 was placed in water so as not to be in contact with the mixture 3 of the ion-exchange resin and the metallic magnesium. A direct current was passed through the apparatus using a DC power source 6. The voltage was fixed to 24 V, which is frequently used for home electronics. After applying current for 1 hour, the concentration of dissolved hydrogen and pH were measured. The concentration of dissolved hydrogen was measured using a dissolved hydrogen meter (UP Corporation, model number: ENH-1000). The pH was measured using a pH meter. In addition, as a comparative control, a sample in which no ion-exchange resin was added and only 10 g of metallic magnesium was added was prepared, and using this, the same experiment was carried out. Results are shown in FIG. 13. Regarding the concentration of dissolved hydrogen after 1 hour, a high concentration of dissolved hydrogen was obtained in the case where the ion-exchange resin was added regardless of whether or not the metallic magnesium was added.

### Example 9

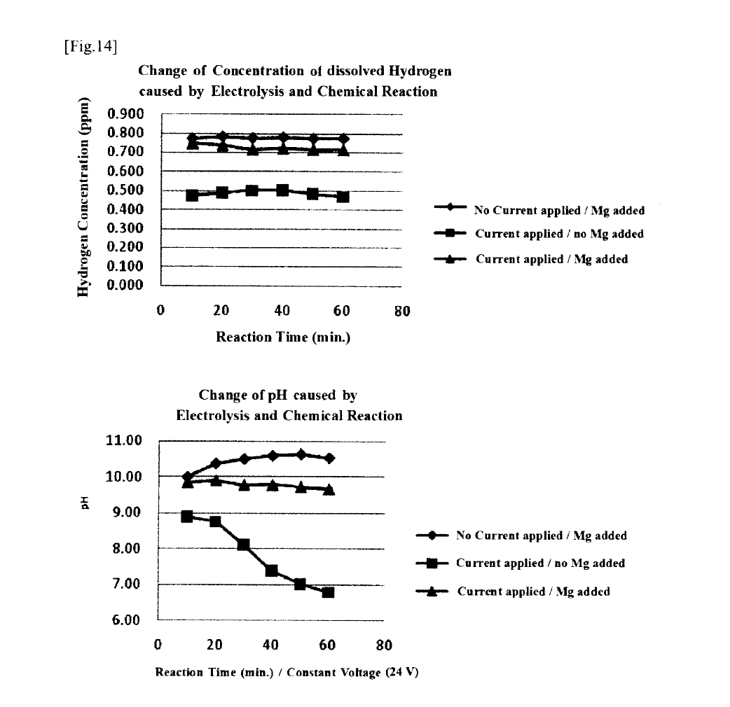

100 ml of tap water was added to a 100 ml beaker. As a cathode, stainless steel (2 cm×5 cm, thickness: 0.3 mm) was used, and as an anode, a carbon rod having a diameter of 9.5 mm and a length of 10 cm was used. A direct current was passed through to perform electrolysis using a power source. The voltage was fixed to 24 V, which is frequently used for home electronics. After applying current for 1 hour, the concentration of dissolved hydrogen and pH were measured. Next, in the same manner, metallic magnesium that is the same as that used in Example 1 was added to a 100 ml beaker as an experimental apparatus. As a cathode, stainless steel was used, and as an anode, a carbon rod was used. FIG. 1 is a schematic view of the experiment. To a beaker 1, 10 g of metallic magnesium 3 was added, and tap water 2 was added thereto to adjust the amount to 100 ml. An anode 4 was contacted with the metallic magnesium 3, which had been precipitated to provide a layer, and a cathode 5 was placed in water so as not to be in contact with the metallic magnesium 3. A direct current (24 V) was passed through the apparatus using a DC power source 6. After applying current for 1 hour, the concentration of dissolved hydrogen and pH were measured. In addition, in the same apparatus as above, no current was passed through and a natural chemical reaction was performed for 1 hour, and then the concentration of dissolved hydrogen and pH were measured. The concentration of dissolved hydrogen was measured using a dissolved hydrogen meter (UP Corporation, model number: ENH-1000). The pH was measured using a pH meter. Results are shown in FIG. 14. When the current was passed though the apparatus without addition of the metallic magnesium, though no metallic magnesium was contained in the apparatus, after the 1-hour reaction, the concentration of dissolved hydrogen became 0.468 ppm, and the pH became 6.78. When the metallic magnesium was added and the current was not passed through the apparatus, after the 1-hour reaction, the concentration of dissolved hydrogen became 0.775 ppm, and the pH became 10.53. Further, when the metallic magnesium was added and the current was passed through the apparatus, after the 1-hour reaction, the concentration of dissolved hydrogen became 0.715 ppm, the pH became 9.67, and a drinkable reduced water (hydrogen-enriched water) having a pH of 10 or less was obtained. When the current was passed through the apparatus to which the metallic magnesium was added, the concentration of dissolved hydrogen was not significantly different from the ease where no current was passed through, but the pH was reduced. As the reaction of the metallic magnesium progresses, the ability to chemically produce hydrogen is reduced on a long-term basis. However, it is thought that when current is applied to the electrodes of the apparatus, the concentration of dissolved hydrogen related to hydrogen generated by electrolysis is maintained independently from the reaction of the metallic magnesium.

### Example 10

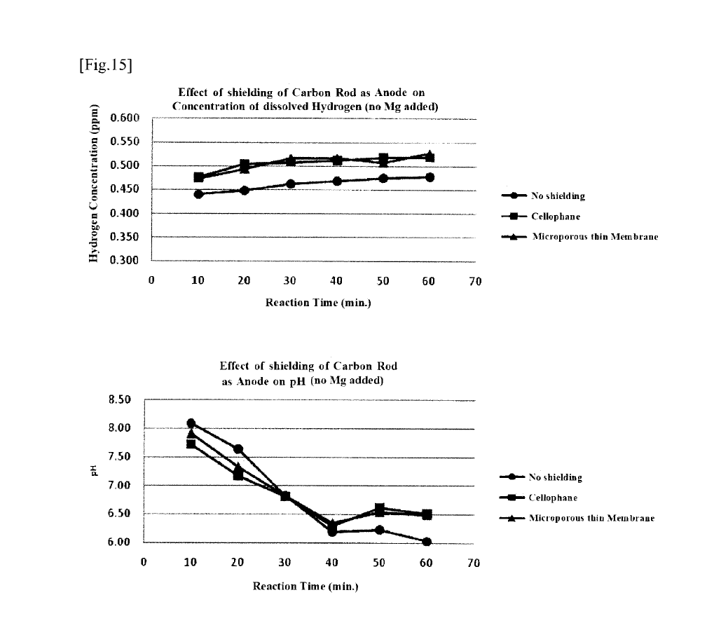

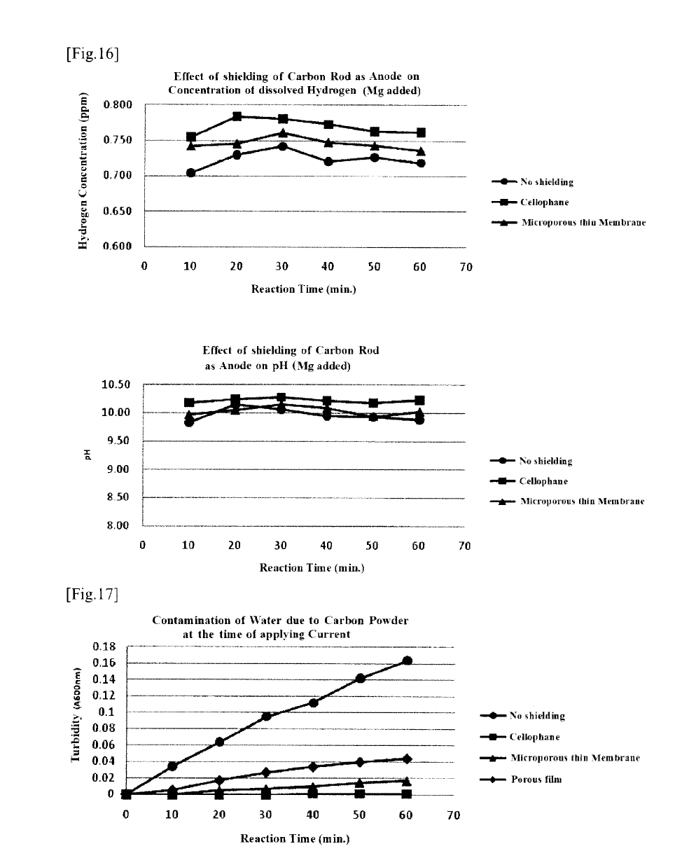

100 ml of tap water was added to a 100 ml beaker. As a cathode, stainless steel (2 cm×5 cm, thickness: 0.3 mm) was used, and as an anode, a carbon rod having a diameter of 9.5 mm and a length of 10 cm was used. In every experiment, direct current was passed through to perform electrolysis using a power source. The carbon rod as the anode was wrapped with a film or filter paper as a coating member. As the film, an ultrahigh molecular weight polyethylene porous film SUNMAP (registered trademark) (Nitto Denko Corporation), a microporous thin membrane Yumicron (registered trademark) electrolytic barrier membrane (Yuasa M&B Co., Ltd., MF-90B) and cellophane (Rengo Co., Ltd.) were used. The voltage was fixed to 24 V, which is frequently used for home electronics. Next, in the same manner, metallic magnesium that is the same as that used in Example 1 was added to a 100 ml beaker as an experimental apparatus. FIG. 1 is a schematic view of the experiment. To a beaker 1, 10 g of metallic magnesium 3 was added, and tap water 2 was added thereto to adjust the amount to 100 ml. An anode 4 was contacted with the metallic magnesium 3, which had been precipitated to provide a layer, and a cathode 5 was placed in water so as not to be in contact with the metallic magnesium 3. A current was passed through the apparatus using a DC power source 6. After applying current for 1 hour, the concentration of dissolved hydrogen and pH were measured. The concentration of dissolved hydrogen was measured using a dissolved hydrogen meter (UP Corporation, model number: ENH-1000). The pH was measured using a pH meter. Results are shown in FIGS. 15 and 16.

In the case of the apparatus to which no metallic magnesium was added, when the carbon rod was not wrapped with the coating member, the concentration of dissolved hydrogen after 1 hour was 0.478 ppm, but when using the cellophane or microporous thin membrane Yumicron (registered trademark) electrolytic barrier membrane, the concentration was 0.52 to 0.53 ppm. Regarding the pH after 1 hour, when the carbon rod was not wrapped with the coating member, the pH was 6.0, and when using the cellophane or microporous thin membrane Yumicron (registered trademark) electrolytic barrier membrane, the pH was about 6.5. In the case of the apparatus to which metallic magnesium was added, when the carbon rod was not wrapped with the coating member, the concentration was 0.719 ppm, and when using the cellophane or microporous thin membrane Yumicron (registered trademark) electrolytic barrier membrane, the concentration was 0.762 ppm or 0.736 ppm. Regarding the pH, when the carbon rod was not wrapped with the coating member, the pH was 9.88, and when using the cellophane, the pH was 10.23.

In addition, in the apparatus to which no metallic magnesium was added, the carbon rod as the anode was wrapped with a cellophane or microporous thin membrane Yumicron (registered trademark) electrolytic barrier membrane similarly, or newly with an ultrahigh molecular weight polyethylene porous film SUNMAP (registered trademark) (Nitto Denko Corporation). The voltage was fixed to 24 V, and after applying current for 1 hour, the absorbance of the solution (wavelength: 600 nm) was measured. The absorbance was measured using an ultra-violet and visible spectrophotometric (Shimadzu Corporation, UV-160A). It is known that by measuring the absorbance at this wavelength, the concentration of fine particles can be known. Results are shown in FIG. 17. After the 1-hour reaction, in the case of the carbon rod without the coating member, there were many carbon fine particles, but in the case of using the microporous thin membrane Yumicron (registered trademark) electrolytic barrier membrane or cellophane, almost no carbon fine particle was present. Thus, when using the microporous thin membrane Yumicron (registered trademark) electrolytic barrier membrane or cellophane, generation of carbon fine particles, which are induced by a reaction in which hydroxide ions are reacted with the carbon rod to generate carbon dioxides, or migration of such carbon fine particles into water was suppressed, and there was no change of the pH or concentration of dissolved hydrogen which would cause practical problems, and it was found that these membrane members are suitable for preparation of reduced water (hydrogen-enriched water) as drinkable water.

### Example 11

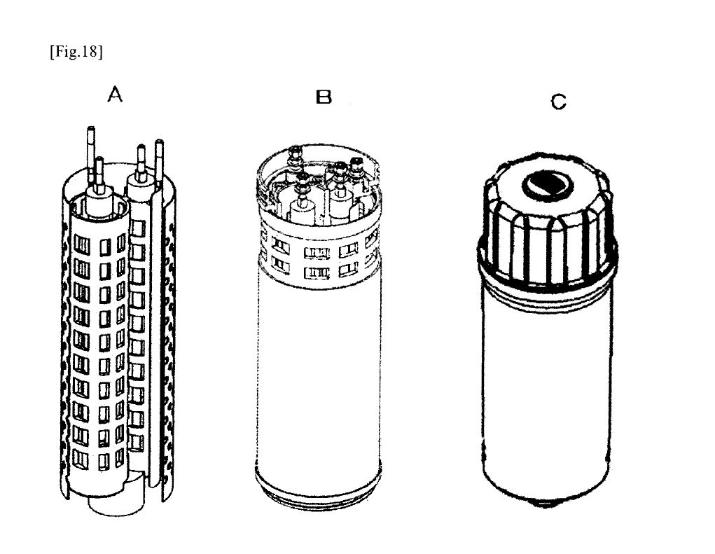

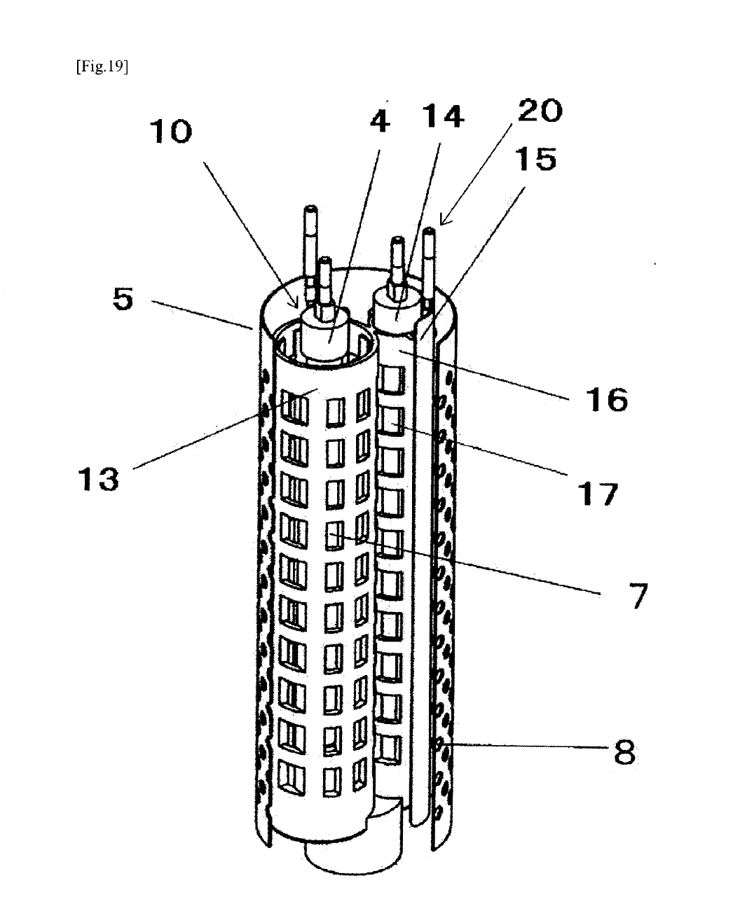

Next, using the apparatus shown in FIGS. 18 and 19, preparation of reduced water (hydrogen-enriched water) was tried. In this reduced water (hydrogen-enriched water) preparation apparatus, first and second tubular oxidation-reduction systems, each of which comprises an anode and a cathode, are provided, and on this point, this working example is different from the aforementioned working examples. FIG. 18 is a schematic view of the apparatus. FIG. 18A shows the internal structure of the reduced water preparation apparatus, and as described below, 2 carbon rods as anodes, 2 stainless cathodes, etc. are contained therein. In this reduced water preparation apparatus, the internal structural body of FIG. 18A is covered by an internal plastic case, and the internal case structure of the internal structural body and the internal plastic case has the appearance shown in FIG. 18B. This internal case structure is further covered by an external plastic case, and the entire apparatus including the external plastic case has the appearance shown in FIG. 18C.

FIG. 19 specifically shows the internal structural body (FIG. 18A) of the apparatus involved in hydrogen generation. A carbon rod 4 is placed in a plastic case 13 having holes 7. All the holes 7 are sealed with nylon mesh and constituted such that water is passed through but the content is not leaked to the outside. Further, a stainless steel 5 having holes 8 is placed at the circumference thereof. The first carbon rod 4 is an anode and constitutes a first oxidation-reduction system 10 (first circuit) together with the stainless steel 5 that is a cathode. Further, a second carbon rod 14 is placed in a second plastic case 16 having holes 17. All the holes 17 are sealed with nylon mesh and constituted such that water is passed through but the content is not leaked to the outside. At the outside thereof, a rectangular stainless steel 15 with no hole is placed so as to be in contact with the second plastic case 16. The second carbon rod 14 is an anode and constitutes a second oxidation-reduction system 20 (second circuit) together with the stainless steel 15 that is a cathode. In the first oxidation-reduction system 10, the first carbon rod 4 placed in the center is surrounded by 13.1 g of metallic magnesium, 6.6 g of ion-exchange resin and 10.85 g of activated carbon. The second oxidation-reduction system 20, which is present adjacent to the first oxidation-reduction system 10 (first circuit), constitutes the second circuit. Note that in FIGS. 18A and 19, a part of the stainless steel 5 is cut off in order to depict the oxidation-reduction systems 10 and 20, but in the actual reduced water (hydrogen-enriched water) preparation apparatus, the stainless steel 5 is placed to surround a pair of the oxidation-reduction systems 10 and 20. The inside of a cassette of the reduced water preparation apparatus, that is, the inside of the internal plastic case (FIG. 18B) was filled with tap water. After that, the voltage was fixed to 24 V, which is frequently used for home electronics, and a direct current of 50 mA and a direct current of 200 mA were applied to the first and second oxidation-reduction systems 10 and 20 (first circuit and second circuit), respectively. After that, the concentration of dissolved hydrogen and pH were measured.

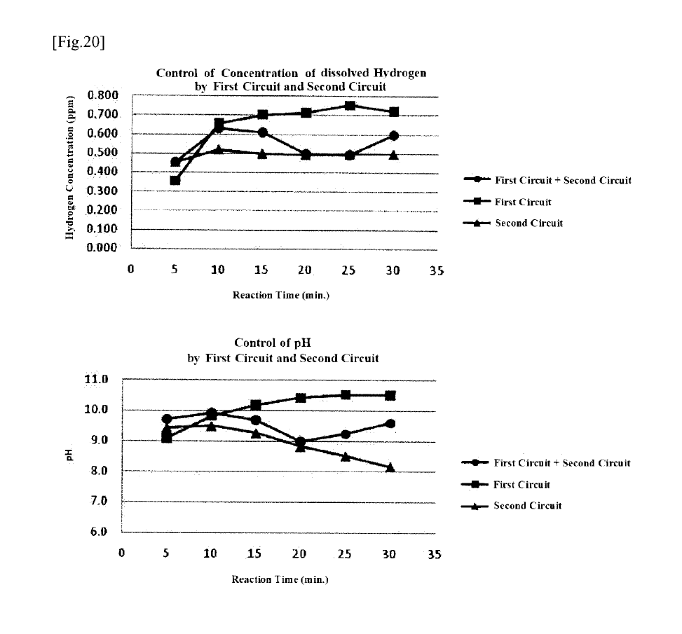

Next, the inside of the cassette was filled with tap water, and then the voltage was fixed to 24 V and a current of 50 mA was applied only to the first oxidation-reduction system 10 (first circuit). After that, the concentration of dissolved hydrogen and pH were measured. Further, the inside of the cassette was filled with tap water, and then the voltage was fixed to 24 V and a current of 200 mA was applied only to the second oxidation-reduction system 20 (second circuit). After that, the concentration of dissolved hydrogen and pH were measured. The concentration of dissolved hydrogen was measured using a dissolved hydrogen meter (UP Corporation, model number: ENH-1000). The pH was measured using a pH meter. Results of the measurement are shown in FIG. 20. When compared to the case where the first and second oxidation-reduction systems 10 and 20 (first circuit and second circuit) were used in combination, in the case where the current was applied only to the first oxidation-reduction system 10 (first circuit), the concentration of dissolved hydrogen in water was increased and the pH was increased. Meanwhile, in the case where the current was applied only to the second oxidation-reduction system 20 (second circuit), the concentration of dissolved hydrogen in water was increased and the pH was decreased. Thus, by providing at least two pairs of the oxidation-reduction systems and adjusting the current and voltage to be applied to the first circuit and those to be applied to the second circuit independently, the concentration of dissolved hydrogen and pH of the reduced water (hydrogen-enriched water) can be finely adjusted.

The holes 7 provided to the first plastic case 13 constituting the first oxidation-reduction system 10 and the holes 17 provided to the second plastic case 16 constituting the second oxidation-reduction system are sealed with nylon mesh, and therefore, water can pass therethrough but materials inside cannot move to the outside. Under the circumstances, carbon dioxide generated from the carbon rods is dissolved in water to provide carbonic acid, and it is rapidly diffused in the cassette. Therefore, the solubility of carbon dioxide in the cassette can be increased.

The reduced water (hydrogen-enriched water) preparation apparatus of the present invention may be, for example, incorporated into a container such as a stick, a cup, a tank, a water server and an exchangeable cassette, an apparatus or the like for use.

1. A method for producing reduced water, wherein a porous solid phase is used in a method for generating hydrogen in water using metallic magnesium.

2. The method for producing reduced water according to claim 1, wherein the solid phase has ion exchange effects.

3. The method for producing reduced water according to claim 1, wherein the solid phase has an acidic functional group.

4. The method for producing reduced water according to claim 1, wherein the solid phase has a sulfonic acid group.

5. The method for producing reduced water according to claim 1, wherein the solid phase has a carboxylic acid group.

6. The method for producing reduced water according to claim 1, wherein the solid phase is a resin.

7. The method for producing reduced water according to claim 1, wherein the solid phase is an ion-exchange resin.

8. The method for producing reduced water according to claim 1, wherein the solid phase removes hydroxide generated on the surface of the metallic magnesium.

9. The method for producing reduced water according to claim 1, wherein the metallic magnesium is oxidized and hydrogen is generated at a cathode.

10. The method for producing reduced water according to claim 9, wherein the anode is made of a carbon-containing material.

11. A spray apparatus for spraying reduced water produced using the method according to claim 1.

12. A food product or a cosmetic product to which reduced water produced using the method according to claim 1 is added in the form of a liquid, a solid, powder or a paste.

13. An apparatus for producing reduced water in which hydrogen is generated in water using metallic magnesium, wherein a porous solid phase is used.

14. An apparatus for producing reduced water comprising electrodes, wherein metallic magnesium is oxidized and hydrogen is generated at a cathode to produce the reduced water, and wherein the apparatus further comprises a solid phase which removes hydroxide generated on the surface of the metallic magnesium.

15. The apparatus for producing reduced water according to claim 13, which has an anode made of a carbon-containing material.

16. The apparatus for producing reduced water according to claim 13, which further has a coating member for coating the surface of the anode.

17. The apparatus for producing reduced water according to claim 13, the apparatus having a first oxidation-reduction system and a second oxidation-reduction system, each of which comprises the anode and the cathode.

18. An apparatus for producing reduced water in which hydrogen is generated in water using electrodes, wherein the apparatus has an anode made of a carbon-containing material.

19. An apparatus for producing reduced water in which hydrogen is generated in water using metallic magnesium, wherein the apparatus has an anode made or a carbon-containing material.

20. The apparatus for producing reduced water according to claim 18, which further has a coating member for coating the surface of the anode.
